(19) United States
(12) Patent Application Publication
(10) Pub. No.: US 2009/0056679 A1
(43) Pub. Date: Mar. 5, 2009

(54) FUEL SUPPLY SYSTEM

(76) Inventors: Kei Masunishi, Kawasaki-shi (JP); Yoshiyuki Isozaki, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/199,127

(22) Filed: Aug. 27, 2008

(30) Foreign Application Priority Data
Aug. 31, 2007 (JP) 2007-225884

(51) Int. Cl. F02M 37/04

(52) U.S. Cl. 123/506; 123/541

(57) ABSTRACT

A fuel supply system includes a fuel container, fuel channels provided between the fuel container and a fuel cell or a fuel reformer, flow regulating mechanism for regulating flow rate of a fuel flowing through the fuel channel, and cooling mechanism having a cooling portion which cools the fuel such that a relationship P_{fuel} (Ta)>P_{bubble} (Tb) is satisfied before the fuel flows into the flow regulating mechanism, the cooling mechanism allowing the fuel having passed through the cooling portion to flow into the flow regulating mechanism as a single-phase flow of liquid. In the above-described formula, P_{fuel} (Ta) denotes an internal pressure of the fuel container at a room temperature Ta, and P_{bubble} (Tb) denotes a saturated vapor pressure of an evaporated component in the fuel at a cooling temperature Tb.

### CROSS-REFERENCE TO RELATED APPLICATIONS

This application is based upon and claims the benefit of priority from prior Japanese Patent Application No. 2007-225884, filed Aug. 31, 2007, the entire contents of which are incorporated herein by reference.

### BACKGROUND OF THE INVENTION

1. Field of the Invention

The present invention relates to a fuel supply system for fuel cells which supplies a fuel to fuel cells or a fuel reformer.

2. Description of the Related Art

Various small-sized fuel cells have been proposed which can be utilized as a power supply for portable equipment. For portable fuel cells, proposals have been made of, for example, direct methanol fuel cells that supply methanol directly to an anode for power generation and fuel cells that reform an organic fuel into hydrogen gas using a reformer so that the hydrogen gas can be used for power generation.

For the operation of a fuel cell system, it is very important to regulate and stabilize the flow rate of a fuel supplied to the fuel cells or the fuel reformer. As means for regulating the flow rate, for example, piezoelectric actuators and electromagnetic actuators have been proposed which control the opening and closing displacement opening and closing time of a valve. For example, in Research Results from Mechanical Engineering Laboratory; Basic Machine Technology; June, 2000; Sohei MATSUDA, Ryutaro MAEDA; “Bidirectional Valve-less Micropump Produced by DRIE”, a proposal is made that the temperature of an orifice passage with a high flow resistance be controlled so as to regulate the flow rate.

However, with the flow regulating mechanism of the conventional system, if part of the fuel being supplied is evaporated to generate a two-phase flow of gas and liquid, a difference in viscosity coefficient or the like between the gas phase and the liquid phase significantly varies the supply flow rate of the fuel. A variation in fuel flow rate makes a reaction system unstable, thus varying a power generation output.

### BRIEF SUMMARY OF THE INVENTION

The present invention has been made to solve the above-described problems. An object of the present invention is to provide a small-sized fuel supply system that can stabilize the flow rate of a fuel to be supplied to fuel cells or a fuel reformer even if part of the fuel is evaporated to generate a two-phase flow of gas and liquid entering flow regulating mechanism.

The fuel supply system according to the present invention comprises a fuel container, a fuel channel provided between the fuel container and at least one of a fuel cell and a fuel reformer, flow regulating mechanism for regulating flow rate of a fuel flowing through the fuel channel, and cooling mechanism having a cooling portion which cools the fuel such that the following formula is satisfied before the fuel flows into the flow regulating mechanism, the cooling mechanism allowing the fuel having passed through the cooling portion to flow into the flow regulating mechanism as a single-phase flow of liquid,

P_{fuel}(Ta)>P_{bubble}(Tb)

where P_{fuel} (Ta) denotes an internal pressure of the fuel container at a room temperature Ta, and P_{bubble} (Tb) denotes a saturated vapor pressure of an evaporated component in the fuel at a cooling temperature Tb.

### BRIEF DESCRIPTION OF THE SEVERAL VIEWS OF THE DRAWING

FIG. 1 is a perspective view showing the configuration of a fuel supply system according to first embodiment;

FIG. 2 is a schematic perspective view showing the structure of flow regulating mechanism made up of an orifice passage;

FIG. 3 is an exploded perspective view showing the structure of the flow regulating mechanism made up of the orifice passage;

FIG. 4 is a perspective view showing the configuration of a fuel supply system according to second embodiment;

FIG. 5 is a perspective view showing the configuration of and a channel in the fuel supply system according to the second embodiment;

FIG. 6 is a perspective view showing the configuration of a fuel supply system according to third embodiment;

FIG. 7 is a perspective view showing the configuration of and a channel in the fuel supply system according to the third embodiment;

FIG. 8 is a perspective view showing the configuration of a fuel supply system according to fourth embodiment;

FIG. 9 is a characteristic diagram showing the results of experiments involving measurement of a variation in supply flow rate observed after passage through the orifice passage and caused by a difference between a two-phase flow of gas and liquid and a single-phase flow of liquid;

FIG. 10 is a characteristic diagram showing the results of experiments involving measurement of a decrease in temperature observed after passage through the orifice passage and caused by vaporization and adiabatic expansion;

FIG. 11 is a schematic diagram showing the configuration of an experiment apparatus used to check the effect of stabilization of the flow rate based on cooling of a fuel;

FIG. 12 is a composite characteristic diagram showing the results of experiments involving the stabilization of the flow rate based on the cooling of the fuel;

FIG. 13A is a schematic diagram illustrating the mechanism of generation of a two-phase flow of gas and liquid, FIG. 13B is a schematic diagram showing a two-phase flow of gas and liquid in which bubbles remain instead of disappearing, and FIG. 13C is a schematic diagram showing a stable single-phase flow of liquid in which the bubbles have disappeared;

FIG. 14 is a temperature-vapor pressure characteristic diagram illustrating the relationship between the saturated vapor pressure of DME alone and the pressure and temperature in a fuel container and the presence or absence of bubbles;

FIG. 15 is a characteristic diagram showing the relationship between the diameter of a bubble and the difference in pressure between the inside and outside of the bubble;

FIG. 16 is a block diagram showing a fuel cell system according to a fifth embodiment; and

FIG. 17 is a block diagram showing a hydrogen generating system according to a sixth embodiment.

### DETAILED DESCRIPTION OF THE INVENTION

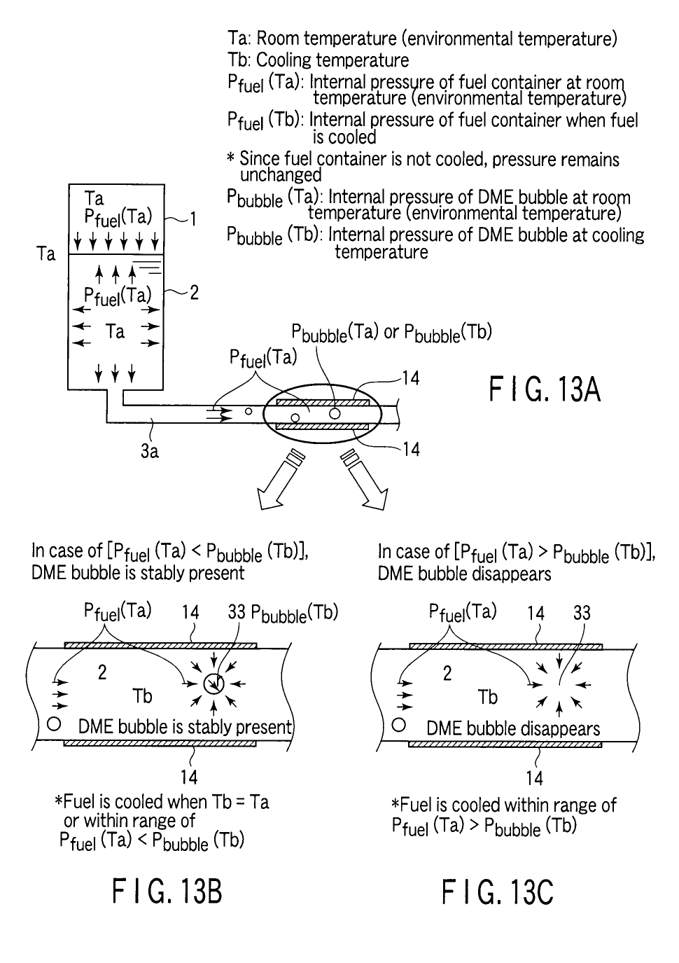

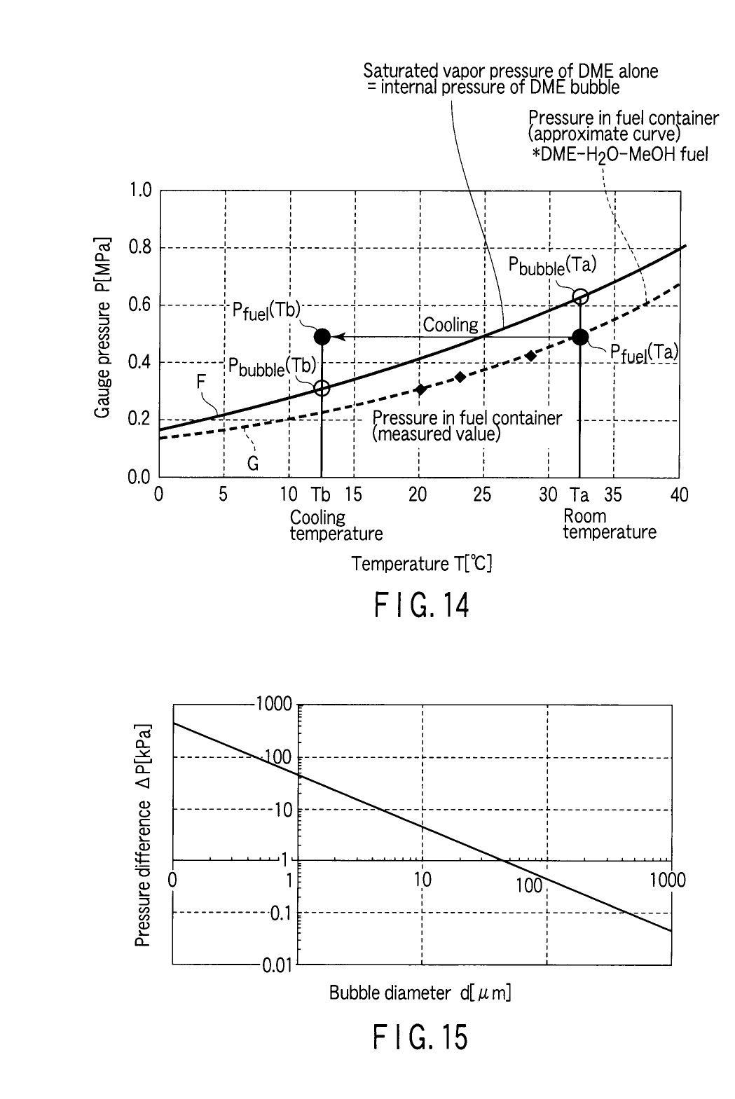

A fuel supply system according to the present invention can use, as a fuel, a fluid containing a pressurized liquefied gas component, for example, hydrocarbon, which can be reformed of dimethylether (DME), methanol, natural gas, propane, butane, or the like to generate hydrogen. The liquefied gas component in the fuel has a high saturated vapor pressure at a room temperature Ta. The liquefied gas component is thus likely to be evaporated to generate bubbles while flowing through a channel. For example, a fuel containing only DME has a saturated vapor pressure of, for example, higher than 0.5 MPa at 25 to 30° C. Thus, the saturated vapor pressure of DME is higher than that of a fuel containing water and methanol in addition to DME. Consequently, at the same temperature, DME bubbles have a higher pressure and can be present in the liquid without being collapsed or disappearing as shown in FIG. 13B. That is, according to Young-Laplace equation (1), shown below, owing to the effect of the surface tension of the liquid, the bubbles can be stably present in such a manner that the bubbles have a pressure P_{bubble} (Ta) higher than the pressure (P_{fuel} (Ta)) of the surrounding fluid by ΔP. Thus, the nucleus 33 of the bubble can be present in such a manner that the nucleus 33 has a diameter enabling the above-described pressure balance to be maintained. The internal pressure of the nucleus 33 of the DME bubble corresponds to a point P_{bubble} (Ta) shown in FIG. 14. FIG. 15 shows the relationship between the diameter d (μm) of the bubble and the difference ΔP (kPa) in pressure between the inside and outside of the bubble. For the surface tension of the liquid, the corresponding value for methanol is utilized.

$$Δ P = \frac{2 σ}{r} \qquad ( 1 )$$

where ΔP: the difference in pressure between the inside and outside of the bubble

r: the radius of the bubble
σ: the surface tension of the liquid.

Thus, the DME bubbles generated are supplied to flow regulating mechanism 4 without being collapsed. This results in a very profound variation that cannot be neglected in connection with the supply flow rate of the fuel. Thus, with reference to FIGS. 13A to 15, description will be given of the mechanism of an operation of cooling a fuel 2 using cooling mechanism 14 to reduce the temperature of the fuel 2 to create a single-phase flow of liquid. The cooling mechanism in FIG. 13A cools the fuel 2 to a temperature Tb (for example, 13° C.). Even in this case, the pressure in the fuel container 1 exhibits the same value (450 kPa) as that observed at the room temperature Ta (for example, 30° C.). This corresponds to a point P_{fuel} (Tb) in FIG. 14.

On the other hand, in an area in which the temperature is reduced by the cooling mechanism 14, the pressure in the DME bubble corresponds to the saturated vapor pressure of DME observed at the cooling temperature Tb (for example, 13° C.). However, this corresponds to a point P_{bubble} (Tb) in FIG. 14, that is, a pressure of 300 kPa, which is lower than the pressure in the fuel container 1 (450 kPa). Consequently, even if the nucleus 33 of the DME bubble is generated in an area with a high DME concentration, the surrounding fuel 2 has a higher pressure, so that the bubble cannot be stably present and is collapsed and disappear. As a result, a single-phase flow of the fuel 2 as a liquid is created in the fuel channel.

The present invention can use an orifice passage with a high flow resistance as flow regulating mechanism. The term “flow resistance” as used in the specification refers to a parameter indicating a pressure loss that may occur when a fluid flows through the channel. When the volume of the fluid flowing for a unit time is defined as Q (m³/s) and the pressure loss resulting from the flow of the fluid through the channel is defined as ΔP (Pa), a fluid resistance R (N·s/m⁵) is given by ΔP/Q (R=ΔP/Q). Reference characters Pa and N denote pascal (the unit of pressure) and Newton (the unit of force), respectively.

Reference characters s and m denote second (the unit of time) and meter (the unit of length).

Given a Hagen-Poiseuille flow, the flow resistance R varies depending on the sectional shape of the channel as described in (i) and (ii).

(i) For a cylindrical pipe channel with a radius a (m) and a length l (m), the flow resistance R is given by:

$$R = \frac{8 μ l}{π {a}^{4}} [ N \cdot s / {m}^{5} ] \qquad ( 2 )$$

where μ denotes the viscosity coefficient [Pa·s] of the fluid.

(ii) For a rectangular pipe channel having a length l (m) and a rectangular cross section with a height 2a (m) and a width 2b (m), the flow resistance R is given by:

$$R = {\{ \frac{{a}^{3} b}{4 μ l} ( \frac{16}{3} - \frac{1024}{{π}^{5}} \frac{a}{b} {\sum }_{n = 1 , 3 , 5 , ⋯}^{∞} \frac{1}{{n}^{5}} tanh \frac{n π b}{2 a} ) \}}^{- 1} [ N \cdot s / {m}^{5} ] \qquad ( 3 )$$

where μ denotes the viscosity coefficient [Pa·s] of the fluid.

An adiabatic expansion portion is further mounted at an outlet of the orifice passage with the high orifice resistance as described above. Thus, the fuel having passed through the orifice passage is adiabatically expanded and exchanges heat with the upstream cooling portion. Then, the relationship P_{fuel} (Ta)>P_{bubble} (Tb) is more likely to be established, making it possible to prevent possible bubbling. Furthermore, even the nucleus 33 of the bubble generated can be reliably made to disappear.

With reference to the attached drawings, description will be given below of various embodiments for carrying out the present invention.

### FIRST EMBODIMENT

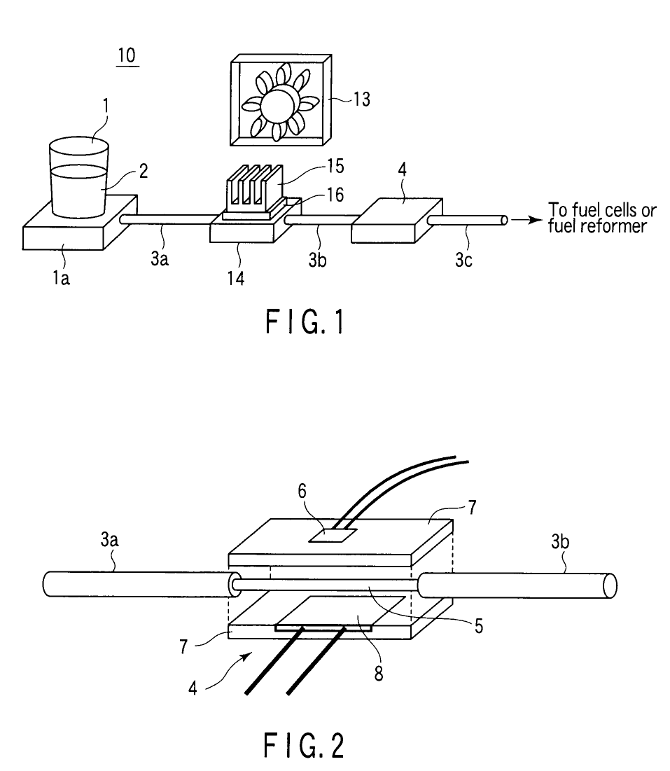

A first embodiment of the present invention will be described with reference to FIGS. 1 to 3. As shown in FIG. 1, a fuel supply system 10 according to the present embodiment comprises a fuel container 1, cooling mechanism 14, flow regulating mechanism 4, a fan 13, and fuel channels 3a, 3b, and 3c. A pressurized and liquefied fuel 2 is accommodated in the fuel container 1. The fuel container 1 is made of a material such as resin or metal. A fuel 2 is a mixed fluid of a liquefied gas (for example, dimethylether) and water or methanol. The mixture ratio of dimethylether (DME) to water is desirably 1:3 to 1:4 in terms of molar ratio. In mixing DME with water, a small amount of methanol can be added. Addition of a small amount of methanol improves the compatibility between DME and water to make the liquid phase of DME and water in the fuel container 1 uniform. In this case, the added methanol desirably amounts to 5 to 10% of the mixture in terms of weight ratio. Even such a small amount of methanol makes the pressure of the mixture higher than the atmospheric pressure. Thus, a saturated vapor pressure of about 3 to 5 atms (about 300 to 500 kPa) is obtained at the room temperature. The fuel container 1 is connected to the cooling mechanism 14 by the fuel channel 3a. An on-off valve 1a is attached to the bottom of the fuel container 1 and controllably turned on and off by control means (not shown). Opening the on-off valve 1a allows the fuel 2 to be introduced from the fuel container 1 into the cooling mechanism 14 through the fuel channel 3a by means of the pressure in the fuel container 1.

As shown in FIG. 1, the cooling mechanism 14 is configured such that a fin 15 is located on a heat radiation side of a Peltier element 16, while the fuel channel 3a, through which the fuel 2 flows, is located on a heat absorption side of the Peltier element 16. The control means (not shown) controls energization of the Peltier element 16 and uses fan 13 to cool the fin 15, located on the heat radiation side. The fuel 2 flowing through the heat absorption side of the Peltier element 16 is thus cooled. The fuel 2 having passed the cooling mechanism 14 is fed to the flow regulating mechanism 4 through the channel 3b. The flow regulating mechanism 4 regulates the flow rate of the fuel 2, which is then fed to fuel cells or a fuel reformer (not shown) through the channel 3c.

As shown in FIG. 2, the flow regulating mechanism 4 is configured such that a pipe of an orifice passage 5 with a high flow resistance is sandwiched between a pair of cover plates 7 made of a material (for example, aluminum) with a high heat conductivity. A thermocouple (or thermistor) 6 is attached to the heat radiation-side cover plate 7. A temperature control element such as a ceramic heater 8 is attached to the heat absorption-side cover plate 7. The orifice passage 5 has a smaller inner diameter than the upstream fuel channel 3a and the downstream fuel channel 3b. The pipe constituting the orifice passage 5 is desirably made of a material having a high heat conductivity and resisting corrosion. However, the material may be any of metal, glass, resin, and the like.

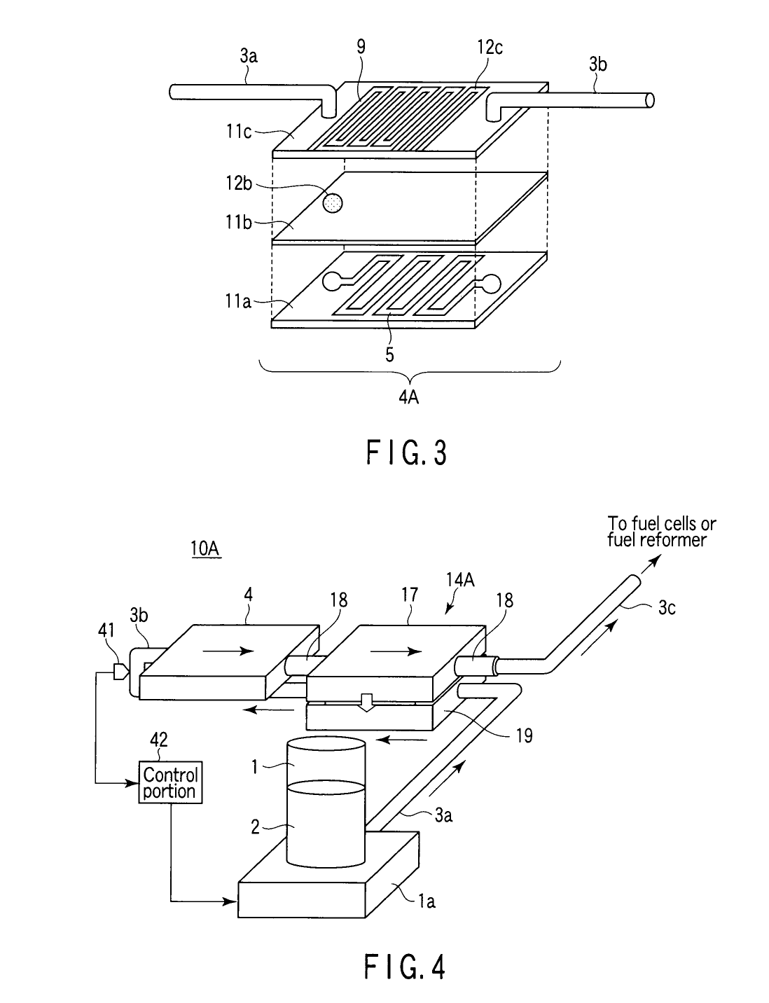

A variation of the flow regulating mechanism may be flow regulating mechanism 4A with a three layer structure having a stack of an orifice passage plate 11a, a filter plate 11b, and a cover plate 11c as shown in FIG. 3. The orifice passage plate 11a has the orifice passage 5 formed by etching or machining. The filter plate 11b is formed by etching or machining and has a filter 12b with a large number of holes smaller than the inner diameter of the orifice passage 5. The cover plate 11c has a patterned thin-film micro heater 9 and a patterned thin-film micro temperature sensor 12c.

In the variation, by controllably energizing the ceramic heater 8 and the thin-film micro heater 9, it is possible to control the orifice passage 5 to a fixed temperature. The flow regulating mechanism 4 may be structured to control the opening and closing displacement and opening and closing time of the valve using a piezoelectric actuator or an electromagnetic actuator (not shown).

The fuel supply system has the above-described flow regulating mechanism 4A according to the variation. Consequently, even if during the feeding of the fuel 2 from the fuel container 1 to the flow regulating mechanism 4A, part of the fuel being fed is evaporated to generate a two-phase flow of gas and liquid, the cooling mechanism 14 can be used to change the two-phase flow back into a single-phase flow of liquid. The single-phase flow can then be allowed to enter the flow regulating mechanism 4A.

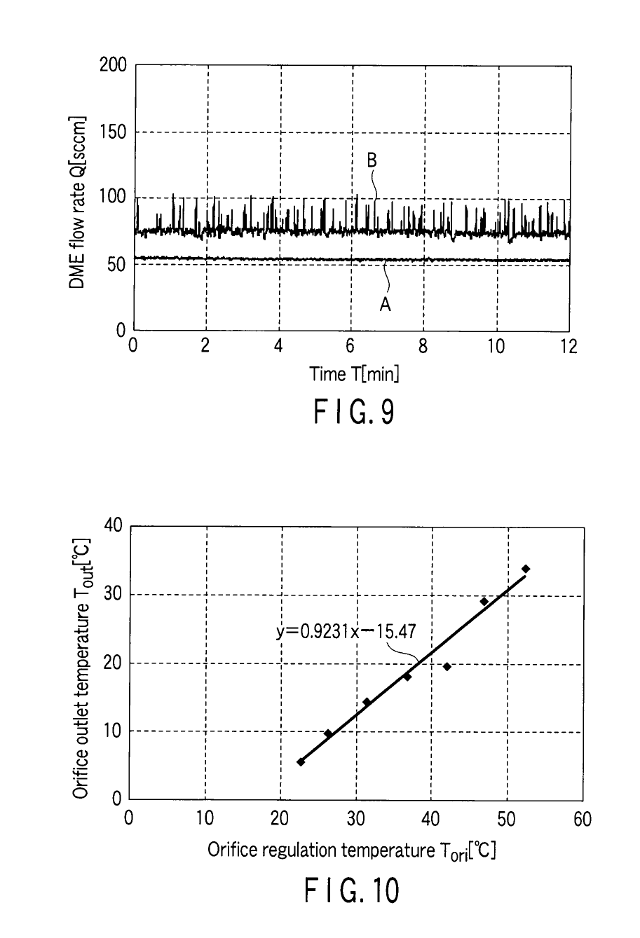

FIG. 9 is a characteristic diagram showing elapsed time T (minute) on the axis of abscissa and a DME flow rate Q (sccm) on the axis of ordinate; FIG. 9 shows a comparison of an example with a comparative example in connection with a temporal variation in flow rate. Here, “sccm” refers to a volume flow rate (cm³/min) in a standard condition (1 atm and 0° C.) In the comparative example in which the fuel 2 changes into a two-phase flow of gas and liquid entering the flow regulating mechanism, the difference between the gas phase and the liquid phase changes the resistance of the fluid. This significantly varies the supply flow rate Q as indicated by a characteristic line B. In contrast, in the example in which the fuel 2 as a single-phase flow of liquid is allowed to flow from the cooling mechanism 14 into the flow regulating mechanism 4, 4A, the supply flow rate Q is stable and is at a fixed level as indicated by a characteristic line A. This makes it possible to stabilize the flow rate of the fuel supplied to the fuel cells or the fuel reformer.

Experiments were performed in which the cooling mechanism 14 was actually installed to cool the fuel 2 to change the fuel 2 into a single-phase flow entering the flow regulating mechanism 4, 4A, to stabilize the fuel supply flow rate. FIG. 11 shows the configuration of an apparatus used in the experiments. The fuel 2 fed from the fuel container 1 was passed through a cooling portion 19 using ice-cold water 28, to reduce the temperature of the fuel 2. The fuel 2 was then allowed to flow into the flow regulating mechanism 4. The fuel 2 having passed through the flow regulating mechanism 4 was then passed through a trap 31. The flow rate of the fuel 2 was then measured using a mass flow meter 32. Reference numerals 27, 31, and 29 denote a pressure gauge, the trap, and a transparent tube, respectively.

FIG. 12 is a composite characteristic diagram showing elapsed time T (minute) on the axis of abscissa and the pressure P (kPa), DME flow rate Q (sccm), and temperature T (° C.) in the fuel container on the axis of ordinate; FIG. 12 shows the results of experiments involving the measurement of variations in pressure, flow rate, and temperature. In FIG. 12, characteristic lines C, D, and E show the variations in the pressure in the fuel container, in DME flow rate Q, and in temperature, respectively.

The cooling mechanism 14 was used to cool the fuel 2 to lower the temperature of the fuel 2 from the room temperature Ta to about 13° C. The thus cooled fuel became a single-phase flow of liquid entering the flow regulating mechanism 4. As a result, the DME flow rate Q was stabilized at about 55 sccm as indicated by the characteristic line D.

Now, with reference to FIGS. 13A, 13B, 13C, 14, and 15, description will be given of the mechanism of change of the fuel 2 into a two-phase flow of gas and liquid.

The fuel 2 is assumed to be a mixed fluid of dimethylether (DME), water, and methanol. The mixture ratio of dimethylether (DME) to water is desirably range of 1:3 to 1:4 in terms of molar ratio. In mixing DME with water, a small amount of methanol can be added. Addition of a small amount of methanol improves the compatibility between DME and water to make the liquid phase of DME and water in the fuel container 1 uniform. In this case, the added methanol desirably amounts to 5 to 10% of the mixture in terms of weight ratio. Even such a small amount of methanol makes the pressure of the mixture higher than the atmospheric pressure. Thus, a saturated vapor pressure of about 3 to 5 atms (about 300 to 500 kPa) is obtained at the room temperature.

FIG. 14 is a temperature-vapor pressure characteristic diagram showing the temperature T (° C.) of the fuel on the axis of abscissa and the gauge pressure P (MPa) in the fuel container on the axis of ordinate; FIG. 14 shows the relationship between the saturated vapor pressure of DME alone and the pressure and temperature in the fuel container and the presence or absence of bubbles. In FIG. 14, a characteristic line F indicates a temperature-saturated vapor pressure (DME bubble internal pressure) characteristic curve for DME alone. A characteristic line G corresponds to a temperature-pressure characteristic curve for the inside of the fuel container. For the pressure in the fuel container shown in FIG. 14, measured values are used.

FIG. 15 is a characteristic diagram showing the diameter d of a DME bubble (μm) on the axis of abscissa and the difference in pressure ΔP (kPa) between the inside and outside of the bubble on the axis of ordinate.

At the room temperature Ta (for example, 30° C.), the internal pressure of the fuel container 1 filled with the fuel 2 has a value intermediate between the saturated vapor pressure of the mixed solution of DME, water and methanol and the saturated vapor pressure. In particular, the interface between the gas and the liquid is considered to be in a DME rich condition and thus exhibits the value of the saturated vapor pressure of DME or a slightly smaller value (450 kPa). This corresponds to a point P_{fuel} (Ta) in FIG. 14.

As shown in FIG. 13A, if the fuel 2 is supplied through the pipe 3a, an area with a high DME concentration may be created in the flow of the fuel 2. In the area with the high DME concentration, the DME gas is formed into a nucleus 33 of a bubble. Since the vapor pressure of DME is higher than that of the fuel 2 as described above, the DME bubble has a higher pressure than the fuel at the same temperature and is thus continuously present instead of being collapsed and disappearing. Furthermore, according to the Young-Laplace equation (1), described above, the effect of the surface tension of the liquid allows the bubble to be stably present in such a manner that the internal pressure of the bubble is higher than the pressure (P_{fuel} (Ta)) of the surrounding fluid by ΔP. Thus, the bubble is present in such a manner that the bubble has a diameter allowing the above-described pressure balance to be maintained. The pressure in the DME bubble corresponds to a point P_{bubble} (Ta) shown in FIG. 14. FIG. 15 shows a variation in the differential pressure ΔP between the inside and outside of the bubble. For the surface tension of the liquid, the value for methanol is utilized.

As described above, the DME bubble generated in the pipe 3a is fed to the flow regulating mechanism 4 without being collapsed, very significantly varying the supply flow rate. Thus, the present invention uses the cooling mechanism 14 to cool the fuel 2 flowing through the channel to lower the temperature of the fuel 2, which becomes a single-phase flow of liquid. This mechanism will be described with reference to FIGS. 13B to 15.

As shown in FIG. 13B, the cooling mechanism 14 is used to cool the fuel 2 to the temperature Tb (for example, 13° C.). Even in this case, the pressure in the fuel container 1 exhibits the same value (450 kPa) as that observed at the room temperature Ta (for example, 30° C.). This corresponds to the point P_{fuel} (Tb) in FIG. 14. On the other hand, in the area with the temperature lowered by cooling mechanism 14, the pressure in the DME bubble is equal to the vapor pressure of DME observed at the cooling temperature Tb (for example, 13° C.). However, this corresponds to the point P_{bubble} (Tb) in FIG. 14, that is, 300 kPa, which is lower than the pressure in the fuel container 1 (450 kPa). Consequently, even if the nucleus 33 of the DME bubble is generated in the area with the high DME concentration, the pressure of the surrounding fuel 2 is higher than that of the bubble. As shown in FIG. 13C, the bubble cannot be stably present in the liquid phase and is thus collapsed and disappears. As a result, a single-phase flow of the fuel 2 as a liquid is created.

### SECOND EMBODIMENT

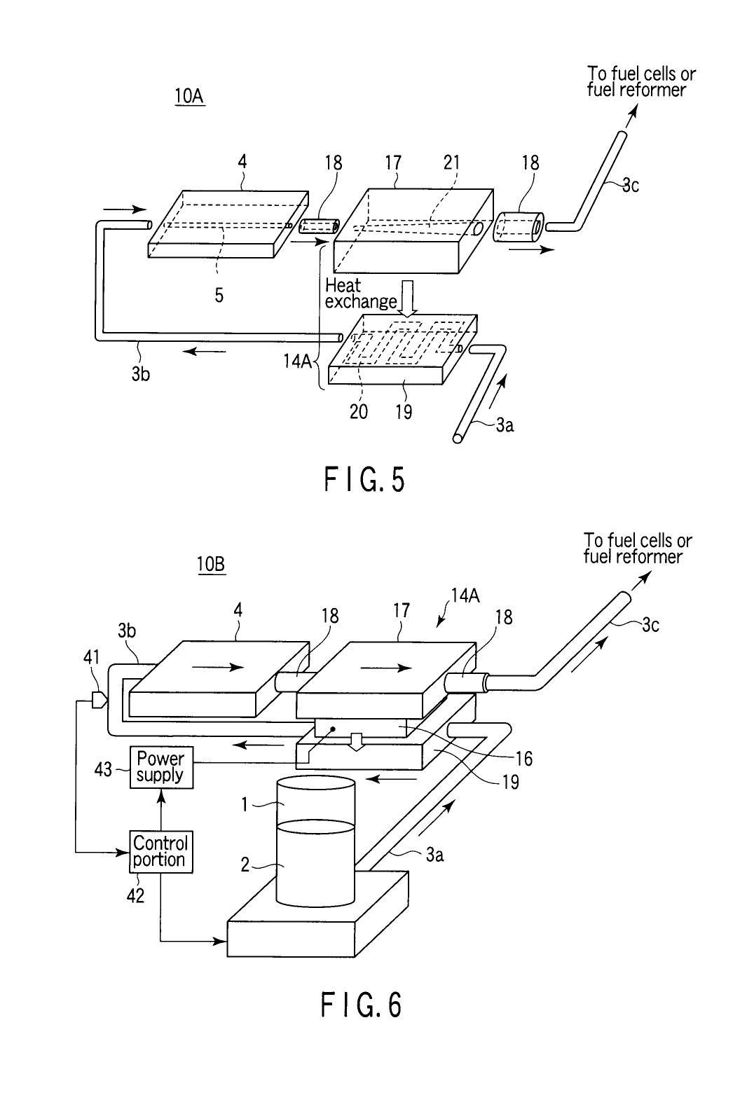

A second embodiment of the present invention will be described with reference to FIGS. 4 and 5. Description of duplications between the present embodiment and the above-described embodiment is omitted.

In a fuel supply system 10A according to the present embodiment, cooling mechanism 14A comprises an adiabatic expansion portion 17. An adiabatic expansion channel 21 having a gradually increasing diameter is formed inside the adiabatic expansion portion 17. Thus, immediately after passing through the orifice passage 5 in the flow regulating mechanism 4, the fuel 2 is adiabatically expanded. The adiabatic expansion portion 17 has a heat radiation surface that is in contact with a heat absorption surface of the cooling portion 19 so that the heat radiation surface can exchange heat with the heat absorption surface. Adiabatic joints 18 are attached to an inlet and an outlet, respectively, of the adiabatic expansion portion 17. The adiabatic expansion portion 17 is thus connected to the orifice passage 5 and to the downstream channel 3c via the respective adiabatic joints 18.

The whole fuel supply system 10A is integrally controlled by a control portion 42. The control portion 42 has various process data and controls the manipulated variables of the on-off valve 1a, a blast fan 13, and a pump (not shown) on the basis of process data and various detection signals (for example, a power generation output detection signal and a cell temperature detection signal) sent by a plurality of sensors (not shown).

In the system 11A according to the present embodiment, the fuel 2 passes through the pipe 3a and is then supplied to the cooling mechanism 14A. After the fuel 2 is cooled while passing through the cooling mechanism 14A, the flow rate of the fuel 2 is regulated by the flow regulating mechanism 4. The fuel 2 is then supplied to the fuel cells or fuel reformer (not shown). The flow regulating mechanism 4 mainly comprises the orifice passage 5 with the high flow resistance. Thus, immediately after the fuel 2 having pressure passes through the orifice passage 5 in the flow regulating mechanism 4, the pressure of the fuel 2 lowers nearly to the atmospheric pressure. Thus, in the adiabatic expansion channel 21, which directly succeeds the orifice passage 5, the fuel 2 is adiabatically expanded or evaporated to lower the temperature of the adiabatic expansion portion 17.

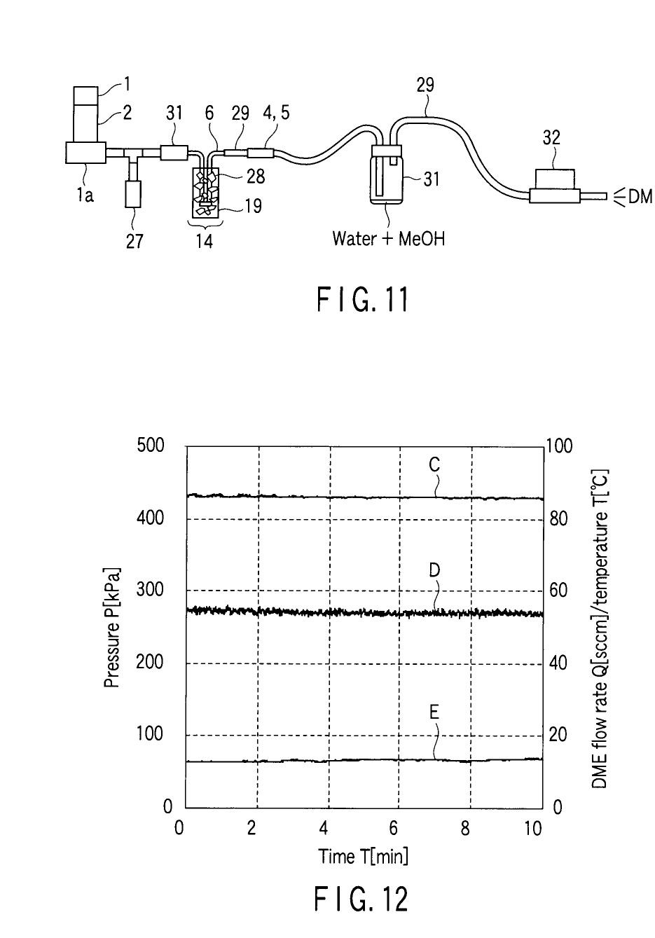

FIG. 10 shows an example of the results of experiments relating to the decrease in temperature. The cooling mechanism 14A is configured to exchange heat between the cooling portion 19 and the adiabatic expansion portion 17, both arranged upstream of the flow regulating mechanism 4. With the fuel supply system configured as described above, even if during the process of feeding the fuel 2 from the fuel container 1 to the flow regulating mechanism 4, part of the fuel being fed is evaporated to generate a two-phase flow of gas and liquid, the cooling mechanism 14A can be used to change the two-phase flow back into the single-phase flow of liquid before allowing the fuel to flow into the flow regulating mechanism 4.

FIG. 9 is a characteristic diagram showing time T (minute) on the axis of abscissa and the flow rate Q (sccm) of dimethylether (DME) on the axis of ordinate; FIG. 9 shows a comparison of the example with the comparative example in connection with a variation in the flow rate of the fuel. In FIG. 9, a characteristic line A indicates a variation in flow rate in the example. A characteristic line B indicates a variation in flow rate in the comparative example.

In the comparative example, as indicated by the characteristic line B, if the fuel 2 changes into a two-phase flow of gas and liquid entering the flow regulating mechanism 4, the difference between the gas phase and the liquid phase significantly varies the supply flow rate. In contrast, in the example, as indicated by the characteristic A, the cooling mechanism 14A is used to cool the fuel 2 to allow the fuel 2 to flow into the flow regulating mechanism 4 as a single-phase flow of liquid. Thus, the flow rate of the fuel supplied to the fuel cells or the fuel reformer can be stabilized.

### THIRD EMBODIMENT

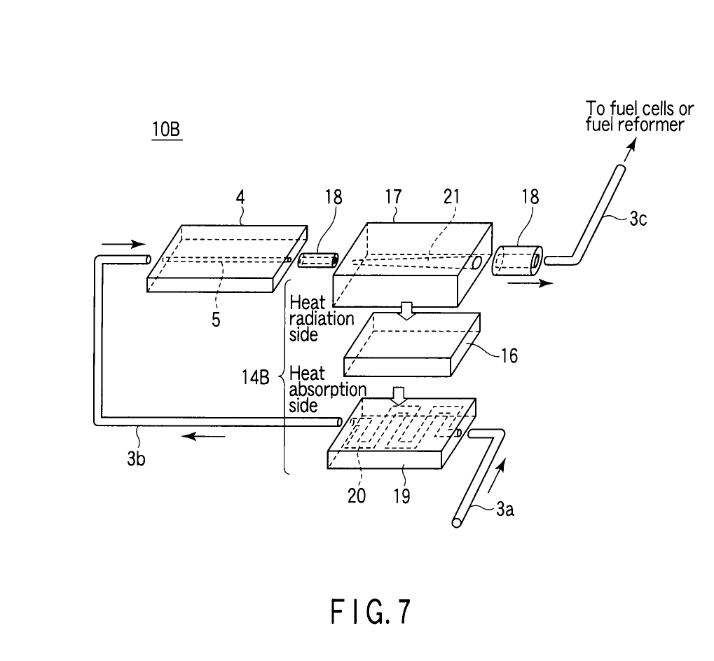

Now, a third embodiment of the present invention will be described with reference to FIGS. 6 and 7. Description of duplications between the present embodiment and the above-described embodiment is omitted.

In a fuel supply system 10B according to the present embodiment, cooling mechanism 14B further comprises a Peltier element 16. The Peltier element 16 is sandwiched between the adiabatic expansion portion 17 and the cooling portion 16. A power supply 43 for the Peltier element 16 is controlled by the control portion 42. A temperature sensor 41 is attached to the fuel channel 3b at an appropriate position. Upon receiving a detection signal for the fuel temperature from the temperature sensor 41, the control portion 42 controls the amount of electricity supplied to the Peltier element 16 on the basis of the signal.

In the system 10B according to the present embodiment, the fuel 2 passes through the pipe 3a and is then supplied to the cooling mechanism 14B. After the fuel 2 is cooled while passing through the cooling mechanism 14B, the flow rate of the fuel 2 is regulated by the flow regulating mechanism 4. The fuel 2 is then supplied to the fuel cells or fuel reformer. The flow regulating mechanism 4 is mainly composed of the orifice passage 5 with the high flow resistance. Thus, immediately after the fuel 2 having pressure passes through the orifice passage 5 in the flow regulating mechanism 4, the pressure of the fuel 2 lowers nearly to the atmospheric pressure. Thus, in the adiabatic expansion channel 21, which immediately succeeds the orifice passage 5, the fuel 2 is adiabatically expanded or evaporated to lower the temperature of the adiabatic expansion portion 17. FIG. 10 shows an example of the results of experiments relating to the decrease in temperature. The cooling mechanism 14B is configured such that the adiabatic expansion portion 17 is located on the heat radiation side of the Peltier element 16, while the cooling portion 19, positioned upstream of the flow regulating mechanism 4, is located on the heat adsorption side of the Peltier element 16. The adiabatic expansion portion 17 cools the heat radiation side of the Peltier element 16 to improve heat absorbing performance exhibited when the Peltier element 16 is controllably energized. The improved heat absorbing performance enables the cooling mechanism 14B to be actuated with reduced power consumption.

With the fuel supply system 10B configured as described above, even if during the process of feeding the fuel 2 from the fuel container 1 to the flow regulating mechanism 4, part of the fuel being fed is evaporated to generate a two-phase flow of gas and liquid, the cooling mechanism 14B can be used to change the two-phase flow back into the single-phase flow of liquid before allowing the fuel to flow into the flow regulating mechanism 4. In the comparative example, as indicated by the characteristic line B in FIG. 9, if the fuel 2 changes into the two-phase flow of gas and liquid entering the flow regulating mechanism 4, the difference between the gas phase and the liquid phase significantly varies the supply flow rate. In contrast, in the example, the cooling mechanism 14B is used to allow the fuel 2 to flow into the flow regulating mechanism 4 as a single-phase flow of liquid. Thus, as indicated by the characteristic line A in FIG. 9, the flow rate of the fuel supplied to the fuel cells or the fuel reformer can be stabilized.

### FOURTH EMBODIMENT

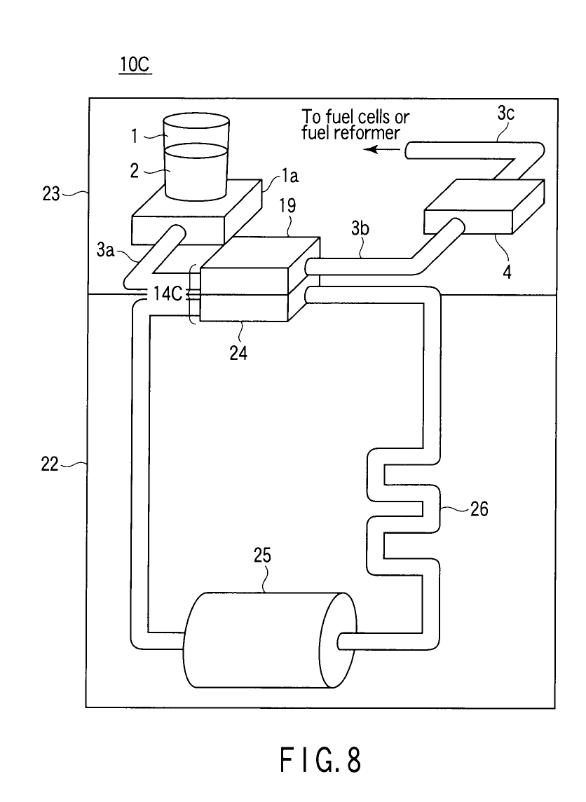

Now, a fourth embodiment of the present invention will be described with reference to FIG. 8. Description of duplications between the present embodiment and the above-described embodiment is omitted.

FIG. 8 is a schematic diagram showing the structure of a refrigerator 10C with fuel cells. Power generated by the fuel cell portion 23 is used to drive components of a refrigerating portion 22. In the refrigerating portion 22, a refrigerant circulating through the refrigerator is compressed by a compressor 25 to change into a gas refrigerant of a high temperature and a high pressure. The gas refrigerant is liquefied by a condenser 26 while radiating heat. The pressure of the refrigerant is reduced, and the refrigerant is evaporated by a cooler 24 to conduct heat away from the surroundings. The refrigerant having performed the required operation returns to the compressor, where the refrigerant is compressed again. This cycle is repeated. In the fuel cell portion 23, the fuel container 1 is full of the fuel 2. The material of the fuel container 1 is composed of a resin material, a metal material, or the like. The fuel 2 is a mixed fluid of a liquefied gas (for example, dimethylether), water, and methanol and has pressure. The fuel 2 passes through the pipe 3a and is then supplied to the cooling mechanism 14C. The fuel 2 passes through the cooling mechanism 14C, where the fuel 2 is cooled. The flow rate of the fuel 2 is then regulated by the flow regulating mechanism 4. The fuel 2 is then supplied to the fuel cells or the fuel reformer. The flow regulating mechanism 4 is mainly composed of the orifice passage 5 with the high flow resistance. The flow regulating mechanism 4 may also be composed of a piezoelectric actuator, an electromagnetic actuator, or the like which controls the opening and closing displacement or opening and closing time of the valve. The cooling mechanism 14C is composed of the cooling portion 19, located upstream of the flow regulating mechanism 4, and the cooler 24 in the refrigerating portion 22, the cooling portion 19 and the cooler 24 exchanging heat with each other.

With the fuel supply system 10C configured as described above, even if during the process of feeding the fuel 2 from the fuel container 1 to the flow regulating mechanism 4, part of the fuel being fed is evaporated to generate a two-phase flow of gas and liquid, the cooling mechanism 14C can be used to change the two-phase flow back into the single-phase flow of liquid before allowing the fuel to flow into the flow regulating mechanism 4.

As shown in FIG. 9, if the fuel 2 changes into the two-phase flow of gas and liquid entering the flow regulating mechanism 4, the difference between the gas phase and the liquid phase significantly varies the supply flow rate. However, by using the cooling mechanism 14C to allow the fuel 2 to flow into the flow regulating mechanism 4 as a single-phase flow of liquid, it is possible to stabilize the flow rate of the fuel supplied to the fuel cells or the fuel reformer can be stabilized.

The present invention can provide a small-sized fuel supply flow rate regulating that can stabilize the flow rate of the fuel to be supplied even if part of the fuel is evaporated to generate a two-phase flow of gas and liquid entering flow regulating mechanism.

### FIFTH EMBODIMENT

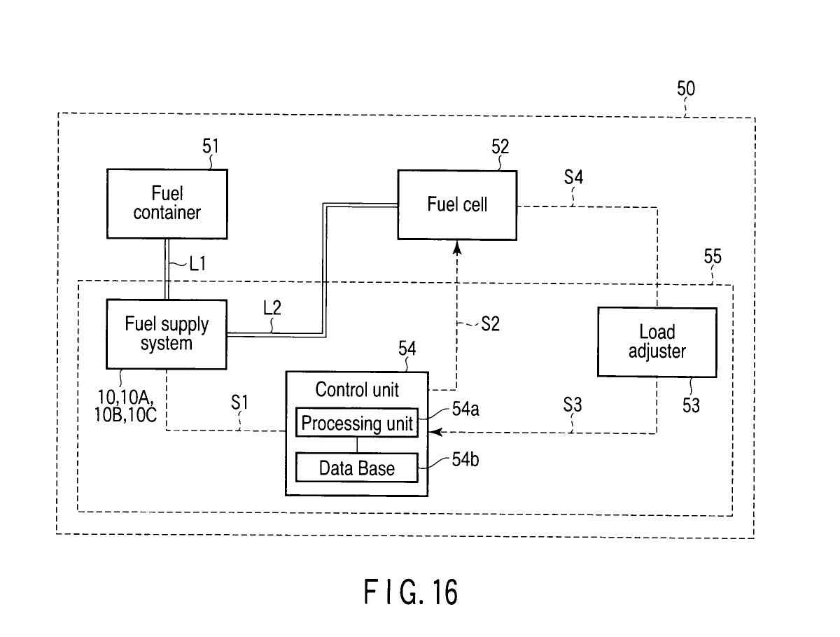

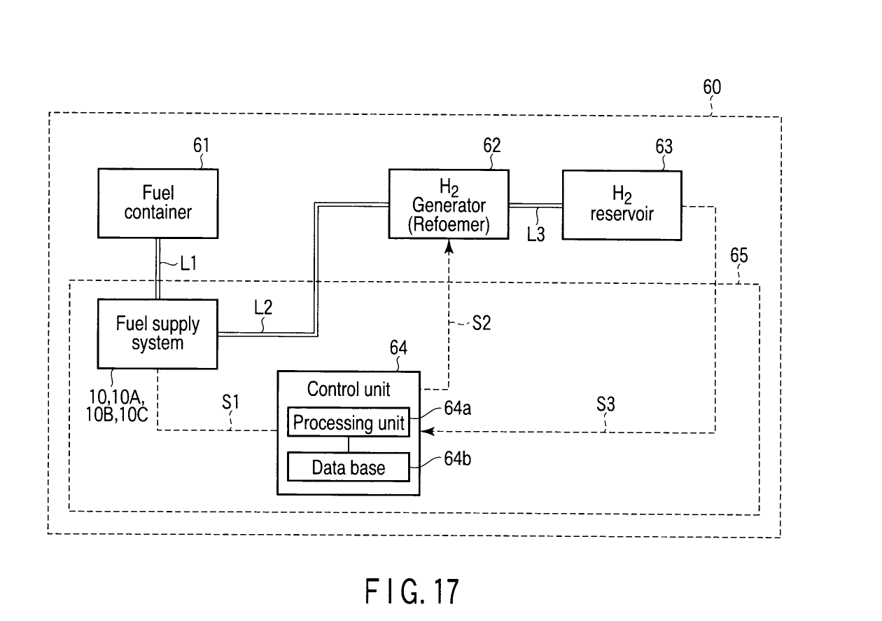

In a fifth embodiment of the present invention, a fuel cell system having a fuel supply system will be described. As shown in FIG. 16, a fuel cell system 50 comprises any one of the fuel supply systems 10, 10A, 10B, and 10C according to the above-described embodiments, a fuel container 51, a fuel cell 52, a load adjuster 53, and a control unit 54. An inlet side of the fuel supply system 10 (10A, 10B, or 10C) is connected to the fuel container 51 via a line L1. An outlet side of the fuel supply system 10 (10A, 10B, or 10C) is connected to the fuel cell 52 via a line L2. The fuel cell 52 contains a membrane electrode assembly having an electrolyte membrane and a catalyst layer. A liquid fuel is supplied to an anode catalyst layer in the membrane electrode assembly. The liquid fuel reacts with oxygen on the cathode side to generate power, which is output to the load adjuster 53 through a wire S4.

The control unit 54 contains a processing unit 54a and a data base 54b to integrally control the whole fuel cell system 50. An I/O unit of the control unit 54 is connected to each of the fuel cell 52, the load adjuster 53, the fuel supply system 10 (10A, 10B, or 10C). Thus, various detection signals for current, voltage, flow rate, temperature, and pressure are input to the processing unit 54a through wires S1, S2, and S3. Control signals are output to each of the fuel cell 52, the load adjuster 53, and the fuel supply system 10 (10A, 10B, and 10C) through the wires S1, S2, and S3. The fuel supply system 10 (10A, 10B, or 10C), the control unit 54, and the load adjuster 53 are formed into one integral unit 55.

In the present embodiment, the flow rate and temperature of the liquid fuel supplied to the fuel cell 52 are adjusted by the fuel supply system 10 (10A, 10B, or 10C). This makes the fuel flow rate constant to stabilize the reaction system, thus preventing a possible variation in power generation output.

### SIXTH EMBODIMENT

In a sixth embodiment of the present invention, a hydrogen generating system comprising a fuel supply system will be described. As shown in FIG. 17, a hydrogen generating system 60 comprises any one of the fuel supply systems 10, 10A, 10B, and 10C according to the above-described embodiments, a fuel container 61, an H₂ generator (reformer) 62, an H₂ reservoir 63, and a control unit 64. An inlet side of the fuel supply system 10 (10A, 10B, or 10C) is connected to the fuel container 61 via the line L1. An outlet side of the fuel supply system 10 (10A, 10B, or 10C) is connected to the H₂ generator (reformer) 62 via the line L2. The H₂ generator 62 has a heating unit, an oxygen supply source, and a fuel reforming catalyst to generate hydrogen from a liquid fuel on the basis of reforming reaction.

The H₂ generator 62 and the H₂ reservoir 63 are connected together via a line L3. Thus, hydrogen generated by the H₂ generator 62 is fed to the H₂ reservoir 63 through the line L3. The hydrogen is then stored in a hydrogen storing alloy or the like.

The control unit 64 contains a processing unit 64a and a data base 64b to integrally control the whole fuel generating system 60. An I/O unit of the control unit 64 is connected to each of the H₂ generator 62, the H₂ reservoir 63, the fuel supply system 10 (10A, 10B, or 10C). Thus, various detection signals for current, voltage, flow rate, temperature, and pressure are input to the processing unit 64a through the wires S1, S2, and S3. Control signals are output to each of the H₂ generator 62, the H₂ reservoir 63, and the fuel supply system 10 (10A, 10B, and 10C) through the wires S1, S2, and S3. The fuel supply system 10 (10A, 10B, or 10C), and the control unit 64 are formed into one integral unit 65.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel supply system comprising:
a fuel container which accommodates a fuel;
a fuel channel communicated with the fuel container;
flow regulating mechanism configured to regulating flow rate of a fuel flowing through the fuel channel; and
cooling mechanism having a cooling portion which cools the fuel such that a following formula is satisfied before the fuel flows into the flow regulating mechanism, the cooling mechanism allowing the fuel having passed through the cooling portion to flow into the flow regulating mechanism as a single-phase flow of liquid,
P_{fuel}(Ta)>P_{bubble}(Tb)
where P_{fuel} (Ta) denotes an internal pressure of the fuel container at a room temperature Ta, and P_{bubble} (Tb) denotes a saturated vapor pressure of a evaporated component in the fuel at a cooling temperature Tb.

2. The system according to claim 1, wherein the flow regulating mechanism is an orifice passage.

3. The system according to claim 2, further comprising an adiabatic expansion portion provided at an outlet of the orifice passage to adiabatically expand the fuel having passed through the orifice passage and to allow the fuel to exchange heat with the cooling portion.

4. The system according to claim 2, further comprising a Peltier element having a heat radiation side configured to exchange heat with the adiabatic expansion section and a heat absorption side configured to exchange heat with the cooling portion; and
a control portion which controls power supply to the Peltier element.

5. The system according to claim 2, further comprising an adiabatic member surrounding the fuel channel.

6. The system according to claim 1, wherein the fuel contains a pressurized liquefied gas component, and the liquefied gas component has a high saturated vapor pressure at a room temperature Ta.

7. A fuel cell system comprising:
a fuel cell;
a fuel container which accommodates a liquid fuel;
a fuel channel formed between the fuel container and the fuel cell;
a flow regulating mechanism configured to regulate flow rate of a fuel flowing through the fuel channel; and
a cooling mechanism having a cooling portion which cools the fuel such that a following formula is satisfied before the fuel flows into the flow regulating mechanism, the cooling mechanism allowing the fuel having passed through the cooling portion to flow into the flow regulating mechanism as a single-phase flow of liquid,
P_{fuel}(Ta)>P_{bubble}(Tb)
where P_{fuel} (Ta) denotes an internal pressure of the fuel container at a room temperature Ta, and P_{bubble} (Tb) denotes a saturated vapor pressure of an evaporated component in the fuel at a cooling temperature Tb.

8. The system according to claim 7, wherein the flow regulating mechanism is an orifice passage.

9. The system according to claim 8, further comprising an adiabatic expansion portion provided at an outlet of the orifice passage to adiabatically expand the fuel having passed through the orifice passage and to allow the fuel to exchange heat with the cooling portion.

10. The system according to claim 8, further comprising a Peltier element having a heat radiation side configured to exchange heat with the adiabatic expansion portion and a heat absorption side configured to exchange heat with the cooling portion; and
a control portion which controls power supply to the Peltier element.

11. The system according to claim 7, further comprising an adiabatic member surrounding the fuel channel.

12. The system according to claim 7, wherein the liquid fuel contains a pressurized liquefied gas component, and the liquefied gas component has a high saturated vapor pressure at the room temperature Ta.

13. A hydrogen generating system comprising:
a fuel reformer;
a fuel container which accommodates a liquid fuel;
a fuel channel formed between the fuel container and the fuel reformer;
a flow regulating mechanism configured to regulate flow rate of a fuel flowing through the fuel channel; and
a cooling mechanism having a cooling portion which cools the fuel such that a following formula is satisfied before the fuel flows into the flow regulating mechanism, the cooling mechanism allowing the fuel having passed through the cooling portion to flow into the flow regulating mechanism as a single-phase flow of liquid,
P_{fuel}(Ta)>P_{bubble}(Tb)
where P_{fuel} (Ta) denotes an internal pressure of the fuel container at a room temperature Ta, and P_{bubble} (Tb) denotes a saturated vapor pressure of an evaporated component in the fuel at a cooling temperature Tb.

14. The system according to claim 13, wherein the flow regulating mechanism is an orifice passage.

15. The system according to claim 14, further comprising an adiabatic expansion portion provided at an outlet of the orifice passage to adiabatically expand the fuel having passed through the orifice passage and to allow the fuel to exchange heat with the cooling portion.

16. The system according to claim 14, further comprising a Peltier element having a heat radiation side configured to exchange heat with the adiabatic expansion portion and a heat absorption side configured to exchange heat with the cooling portion; and
a control portion which controls power supply to the Peltier element.

17. The system according to claim 13, further comprising an adiabatic member surrounding the fuel channel.

18. The system according to claim 13, wherein the liquid fuel contains a pressurized liquefied gas component, and the liquefied gas component has a high saturated vapor pressure at the room temperature Ta.
